(19) United States
(12) Patent Application Publication
(10) Pub. No.: US 2025/0130486 A1
(43) Pub. Date: Apr. 24, 2025

(54) ILLUMINATOR AND PROJECTOR

(71) Applicant: SEIKO EPSON CORPORATION, Tokyo (JP)

(72) Inventor: Koichi AKIYAMA, AZUMINO-SHI (JP)

(21) Appl. No.: 18/923,911

(22) Filed: Oct. 23, 2024

(30) Foreign Application Priority Data
Oct. 23, 2023 (JP) 2023-181632

(51) Int. Cl. G03B 21/20; G02B 27/48; G03B 33/12

(52) U.S. Cl. CPC G03B 21/208; G02B 27/48; G03B 21/2013; G03B 21/2033; G03B 21/2066; G03B 33/12

(57) ABSTRACT

An illuminator according to an embodiment of the present disclosure includes a first laser light source section configured to output first light having a first wavelength band, a second laser light source section configured to output second light having a second wavelength band, a first diffusing member, a second diffusing member, and a light combiner configured to combine the first light and the second light with each other. The first diffusing member includes a first dielectric multilayer film configured to reflect the first light, and the second diffusing member includes a second dielectric multilayer film configured to reflect the second light. Assuming that an angle of incidence of a chief ray of the first light to be incident on the first diffusing member is called a first angle of incidence, and that an angle of incidence of a chief ray of the second light to be incident on the second diffusing member is called a second angle of incidence, the first dielectric multilayer film is characterized by having reflectance in the first wavelength band of the light incident thereon at the first angle of incidence is higher than reflectance in the second wavelength band of the light incident thereon at the first angle of incidence, and the second dielectric multilayer film is characterized by having reflectance in the second wavelength band of the light incident thereon at the second angle of incidence is higher than reflectance in the first wavelength band of the light incident thereon at the second angle of incidence.

The present application is based on, and claims priority from JP Application Serial Number 2023-181632, filed Oct. 23, 2023, the disclosure of which is hereby incorporated by reference herein in its entirety.

### BACKGROUND

### 1. Technical Field

The present disclosure relates to an illuminator and a projector.

### 2. Related Art

To enhance the performance of projectors, there has been proposed a projector including an illuminator using a laser light source, which is a light source that has a wide color gamut and operates at high efficiency. JP-T-2023-523358 discloses a light emitting module including a blue laser light source, a green laser light source, a red laser light source, a light combining system that combines the variety of light output from the laser light sources of three colors, and a diffuser wheel that diffuses light incident thereon.

JP-T-2023-523358 is an example of the related art.

In the light emitting module disclosed in JP-T-2023-523358, the blue light, the green light, and the red light output from the three laser light sources are combined with one another by the light combining system, and the combined light is then diffusively reflected off the diffuser wheel. In this process, a motor is used to rotate the diffuser wheel to reduce speckles unique to laser light. This type of reflective diffuser wheel often uses a dielectric multilayer film having excellent reflectance. It is, however, difficult for the configuration described above, in which white light containing the blue light, the green light, and the red light is incident on the diffuser wheel, to form a dielectric multilayer film having satisfactory reflectance over a wide wavelength band from the blue wavelength band to the red wavelength band, and there is therefore a problem of failure to realize a high-efficiency illuminator.

### SUMMARY

According to an aspect of the present disclosure, an illuminator includes a first laser light source section configured to output first light having a first wavelength band; a second laser light source section configured to output second light having a second wavelength band different from the first wavelength band; a first diffusing member configured to diffusively reflect the first light output from the first laser light source section; a second diffusing member configured to diffusively reflect the second light output from the second laser light source section; and a light combiner configured to combine the first light output from the first diffusing member and the second light output from the second diffusing member with each other and output the combined light. The first diffusing member includes a first dielectric multilayer film configured to reflect the first light. The second diffusing member includes a second dielectric multilayer film configured to reflect the second light. Assuming that an angle of incidence of a chief ray of the first light to be incident on the first diffusing member is called a first angle of incidence, and that an angle of incidence of a chief ray of the second light to be incident on the second diffusing member is called a second angle of incidence, the first dielectric multilayer film is characterized by having reflectance in the first wavelength band of the light incident thereon at the first angle of incidence is higher than reflectance in the second wavelength band of the light incident thereon at the first angle of incidence, and the second dielectric multilayer film is characterized by having reflectance in the second wavelength band of the light incident thereon at the second angle of incidence is higher than reflectance in the first wavelength band of the light incident thereon at the second angle of incidence.

A projector according to another aspect of the present disclosure includes: the illuminator according to the aspect of the present disclosure; a light modulator configured to modulate light containing the combined light output from the illuminator in accordance with image information; and a projection optical apparatus configured to project the light modulated by the light modulator.

### BRIEF DESCRIPTION OF THE DRAWINGS

FIG. 1 is a schematic configuration diagram of a projector according to a first embodiment.

FIG. 2 is a schematic configuration diagram of an illuminator according to the first embodiment.

FIG. 3 is a front view of a diffuser.

FIG. 4 is a cross-sectional view of a diffuser plate taken along the line IV-IV in FIG. 3.

FIG. 5 shows an example of the spectral characteristics of a dielectric multilayer film.

FIG. 6 is a schematic configuration diagram of an illuminator according to a second embodiment.

FIG. 7 shows an example of an optical intensity distribution curve of diffused light.

FIG. 8 is a schematic configuration diagram of an illuminator according to a third embodiment.

### DESCRIPTION OF EMBODIMENTS

### First Embodiment

A first embodiment of the present disclosure will be described below with reference to the drawings.

The projector according to the present embodiment is an example of a liquid crystal projector including an illuminator using laser diodes.

In the following drawings, elements are drawn at different dimensional scales in some cases for clarity of the elements.

A projector 10 according to the present embodiment is a projection-type image display apparatus that displays a color image on a screen (projection receiving surface) SCR. The projector 10 includes three light modulators corresponding to three types of color light, red light LR, green light LG, and blue light LB. The projector 10 includes laser diodes each capable of generating high-luminance, high-optical-output light as light emitters of an illuminator 700.

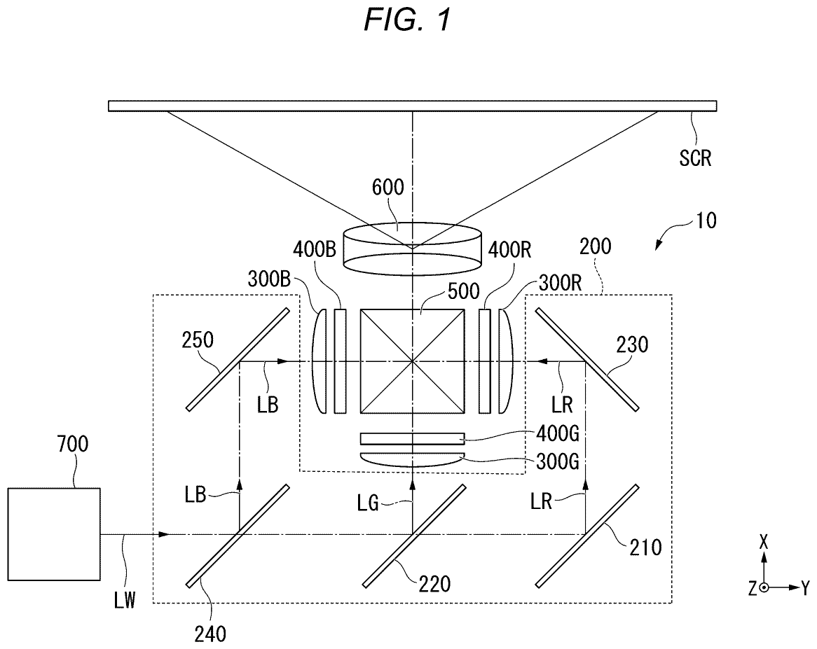

FIG. 1 is a schematic configuration diagram of the projector 10 according to the present embodiment.

The projector 10 includes an illuminator 700, a color separation/light guide system 200, a red light modulator 400R, a green light modulator 400G, a blue light modulator 400B, a light combining system 500, and a projection optical apparatus 600, as shown in FIG. 1. The red light modulator 400R, the green light modulator 400G, and the blue light modulator 400B form image light by modulating light containing combined light LW output from the illuminator 700 in accordance with image information. The projection optical apparatus 600 projects the image light onto the screen SCR (projection receiving surface).

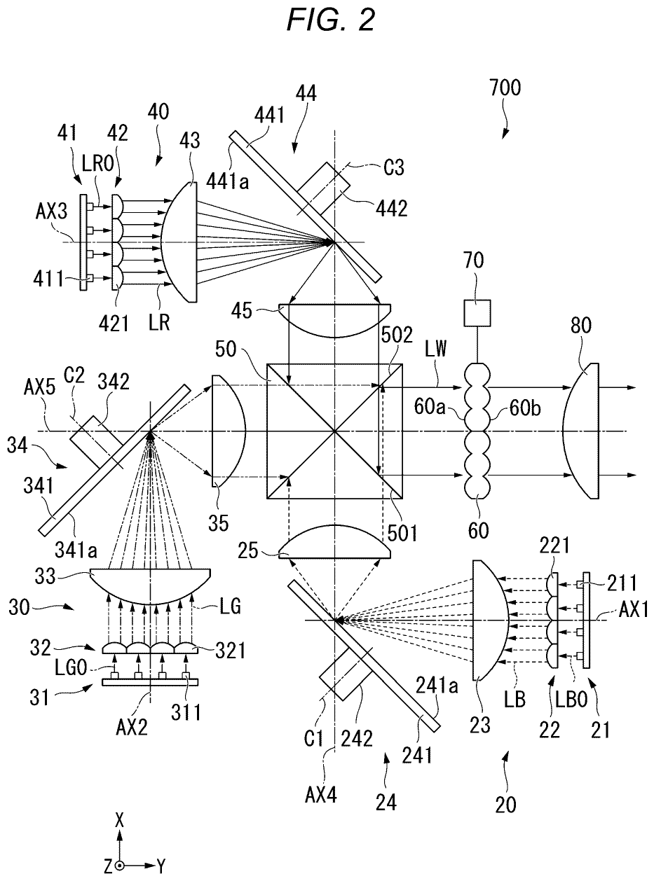

FIG. 2 is a schematic configuration diagram of the illuminator 700.

The illuminator 700 includes a blue light source section 20, a green light source section 30, a red light source section 40, a light combiner 50, a double-sided multi-lens array 60, a displacement apparatus 70, and a superimposing lens 80, as shown in FIG. 2.

In the description below, an axis along the direction in which light is output from the blue light source section 20 and the direction in which light is output from the red light source section 40 is an X-axis, an axis along the direction in which the combined light LW is output from the illuminator 700 is a Y-axis, and the axis perpendicular to the X-axis and the Y-axis is a Z-axis. It is assumed that the optical axis of a first light collecting lens 23 (center axis of blue light LB output from blue laser diode array 21) is an optical axis AX1, that the optical axis of a second light collecting lens 33 (center axis of green light LG output from green laser diode array 31) is an optical axis AX2, that the optical axis of a third light collecting lens 43 (center axis of red light LR output from red laser diode array 41) is an optical axis AX3, that the optical axis of each of a first collimator lens 25 and a third collimator lens 45 that passes through the center of the light combiner 50 is an optical axis AX4, and that the optical axis of a second collimator lens 35 that passes through the center of the light combiner 50 is an optical axis AX5.

The blue light source section 20 includes the blue laser diode array 21, a first collimator lens array 22, the first light collecting lens 23, a first diffuser 24, and the first collimator lens 25.

The blue laser diode array 21 includes multiple blue laser diodes 211 arranged in an array. The blue laser diodes 211 output blue beams LB0 having a first wavelength band in the −Y direction. The first wavelength band is, for example, 455 nm±10 nm. The number of blue laser diodes 211 and the arrangement thereof are not particularly limited to a specific number and a specific arrangement. The blue laser diode array 21 in the present embodiment corresponds to the first laser light source section in the claims.

The first collimator lens array 22 is provided at the light exiting side of the blue laser diode array 21. The first collimator lens array 22 includes multiple collimator lenses 221 provided in correspondence with the respective multiple blue laser diodes 211. The collimator lenses 221 are each configured with a convex lens. The collimator lenses 221 parallelize the blue beams LB0 output from the blue laser diodes 211. The multiple blue beams LB0 output from the first collimator lens array 22 are hereinafter collectively referred to as blue light LB. The blue light LB in the present embodiment corresponds to the first light in the claims.

The first light collecting lens 23 is provided at the light exiting side of the first collimator lens array 22. The first light collecting lens 23 is configured with a convex lens. The first light collecting lens 23 collects the blue light LB output from the first collimator lens array 22, and outputs the collected blue light LB toward a first diffuser plate 241. According to the configuration described above, since the blue light LB collected by the first light collecting lens 23 is incident on the first diffuser plate 241, the first diffuser plate 241 does not need to be unnecessarily enlarged, so that the size of the illuminator 700 can be reduced.

The first diffuser 24 includes the first diffuser plate 241, which is a disk-shaped element, and a driver 242. The first diffuser plate 241 has a diffusing surface 241a, which diffusively reflects the blue light LB output from the first light collecting lens 23. That is, the first diffuser plate 241 in the present embodiment is not a transmissive diffuser plate but a reflective diffuser plate. The diffusing surface of the first diffuser plate 241 is located at the focal position of the first light collecting lens 23. The driver 242 is configured with a motor and rotates the first diffuser plate 241 around an axis of rotation C1, which intersects with the diffusing surface 241a. Note that the diffusing surface 241a in the present specification does not mean a curved surface having a shape of a fine uneven structure that will be described later, but means a single surface at which multiple recesses and multiple protrusions are generally arranged. The first diffuser plate 241 in the present embodiment corresponds to the first diffusing member in the claims.

The first diffuser plate 241 is so disposed that the diffusing surface 241a forms an angle of 45° with each of the optical axes AX1 and AX4. That is, the diffusing surface 241a inclines by 45° with respect to the optical axis AX1 of the first light collecting lens 23. The chief ray of the blue light LB output from the first light collecting lens 23 is incident on the diffusing surface 241a at an angle of incidence of 45°. According to the configuration described above, the traveling direction of the chief ray of the blue light LB to be incident on the diffusing surface 241a can be substantially perpendicular to the traveling direction of the chief ray of the blue light LB output from the diffusing surface 241a. The illuminator 700 can therefore be readily designed.

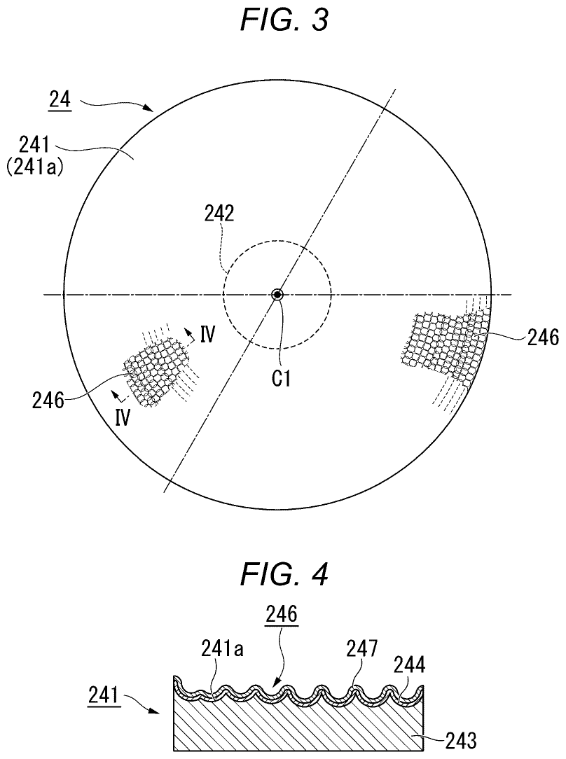

FIG. 3 is a front view of the first diffuser 24. FIG. 4 is a cross-sectional view of the first diffuser plate 241 taken along the line IV-IV in FIG. 3. The configuration of the first diffuser plate 241 is the same as those of a second diffuser plate 341 and a third diffuser plate 441 except for the specifications of a dielectric multilayer film. Therefore, the first diffuser plate 241 will be described in detail as a representative diffuser plate, and detailed description of the second diffuser plate 341 and the third diffuser plate 441 will be omitted in the following description.

The first diffuser plate 241 includes a light transmissive substrate 243, a metal reflection film 244, and a dielectric multilayer film 247, as shown in FIGS. 3 and 4. The dielectric multilayer film 247 corresponds to the first dielectric multilayer film in the claims. The metal reflection film 244 corresponds to the metal film in the claims.

The light transmissive substrate 243 is made, for example, of optical glass such as BK7. Out of the two surfaces of the light transmissive substrate 243, the diffusing surface 241a, on which the blue light LB is incident, is provided with an uneven structure 246 configured with multiple recesses and multiple protrusions. The uneven structure 246 has multiple randomly arranged curved surfaces. That is, the light transmissive substrate 243 has the uneven structure 246 including multiple recesses and multiple protrusions. The recesses are each formed in a substantially spherical shape. The depth of each of the recesses is, for example, about a quarter of the diameter of the spherical surface. The uneven structure 246 can be formed by a method for scraping the light transmissive substrate 243, for example, in an etching process, or plastically deforming the light transmissive substrate 243, for example, in a blasting process.

The metal reflection film 244 is provided along the uneven structure 246 of the light transmissive substrate 243. The metal reflection film 244 is made, for example, of an aluminum-containing material. Specifically, the metal reflection film 244 is made of high-purity aluminum having an aluminum content of 99.99 wt % or greater. The metal reflection film 244 can be preferably made of ultra-high-purity aluminum having an aluminum content of 99.999 wt % or greater.

The metal reflection film 244 is produced by forming a pure aluminum film having a smooth surface and having a predetermined film thickness at the diffusing surface 241a of the light transmissive substrate 243 by using a film formation method such as sputtering or vapor deposition. In the film formation step, when a sputtering target having an aluminum content of, for example, 99.999 wt % is used, the metal reflection film 244 made of ultra-high-purity aluminum having the aluminum content of 99.999 wt % is produced.

The dielectric multilayer film 247 is provided at a surface of the metal reflection film 244 that is opposite from the light transmissive substrate 243. That is, the first diffuser plate 241 has a configuration in which the metal reflection film 244 and the dielectric multilayer film 247 are layered in this order on the light transmissive substrate 243. Although not shown in FIG. 4, the dielectric multilayer film 247 has a configuration in which two types of dielectric films having different refractive indices are alternately layered multiple times.

In the first diffuser plate 241 in the present embodiment, the uneven structure 246 reflects once the blue light LB output from the first light collecting lens 23 and outputs the reflected blue light LB toward the first collimator lens 25. The blue light LB output from the first light collecting lens 23 is therefore output from the first diffuser plate 241 toward the first collimator lens 25 without reflected off the diffusing surface 241a multiple times. According to the configuration described above, since the blue light LB output from the first light collecting lens 23 is not reflected off the diffusing surface 241a multiple times, disturbance of the polarization direction of the blue light LB can be suppressed. The first diffuser plate 241 may instead be a microlens-array-type diffuser plate including a microlens array.

In place of the configuration shown in FIG. 4, the first diffuser plate 241 may not be provided with the metal reflection film, but the dielectric multilayer film may be directly formed on the uneven structure of the light transmissive substrate. The configuration described above can simplify the step of manufacturing the first diffuser plate. When the metal reflection film is provided, however, the metal reflection film and the dielectric multilayer film both have the reflection function, so that the number of layers in the dielectric multilayer film can be reduced.

The first diffuser plate may instead be configured with a metal substrate and a dielectric multilayer film. The metal substrate can, for example, be made of an aluminum alloy. The aluminum alloy is, for example, an Al—Mg—Si-based alloy primarily made of aluminum (Al) to which magnesium (Mg) and silicon (Si) are added. In addition, the aluminum alloy may contain elements such as iron (Fe), copper (Cu), manganese (Mn), chromium (Cr), zinc (Zn), and titanium (Ti). In this case, an uneven structure may be formed at one surface of the metal substrate by blasting the metal substrate, and the dielectric multilayer film may be formed on the uneven structure. The configuration described above can simplify the configuration of the first diffuser plate.

The first collimator lens 25 is provided in the optical axis AX4 at the light exiting side of the first diffuser plate 241, as shown in FIG. 2. The first collimator lens 25 is configured with a convex lens. The first collimator lens 25 parallelizes the blue light LB output from the first diffuser plate 241 at a predetermined diffusion angle, and outputs the parallelized blue light LB toward the light combiner 50.

The green light source section 30 includes the green laser diode array 31, a second collimator lens array 32, the second light collecting lens 33, a second diffuser 34, and the second collimator lens 35. The basic configuration of each of the elements of the green light source section 30 is the same as that of each of the elements of the blue light source section 20, and the same portions will therefore not be described.

The green laser diode array 31 includes multiple green laser diodes 311 arranged in an array. The green laser diodes 311 output green beams LG0 having a second wavelength band in the +X direction. The second wavelength band is, for example, 535 nm±10 nm. The number of green laser diodes 311 and the arrangement thereof are not particularly limited to a specific number and a specific arrangement. The green laser diode array 31 in the present embodiment corresponds to the second laser light source section in the claims.

The second collimator lens array 32 is provided at the light exiting side of the green laser diode array 31. The second collimator lens array 32 includes multiple collimator lenses 321 provided in correspondence with the respective multiple green laser diodes 311. The collimator lenses 321 are each configured with a convex lens. The collimator lenses 321 parallelize the green beams LG0 output from the green laser diodes 311. The multiple green beams LG0 output from the second collimator lens array 32 are hereinafter collectively referred to as green light LG. The green light LG in the present embodiment corresponds to the second light in the claims.

The second light collecting lens 33 is provided at the light exiting side of the second collimator lens array 32. The second light collecting lens 33 is configured with a convex lens. The second light collecting lens 33 collects the green light LG output from the second collimator lens array 32, and outputs the collected green light LG toward the second diffuser plate 341.

The second diffuser 34 includes the second diffuser plate 341, which is a disk-shaped element, and a driver 342. The second diffuser plate 341 has a diffusing surface 341a, which diffusively reflects the green light LG output from the second light collecting lens 33. The diffusing surface 341a of the second diffuser plate 341 is located at the focal position of the second light collecting lens 33. The configuration of the driver 342 is the same as that of the driver 242 of the blue light source section 20. The driver 342 rotates the second diffuser plate 341 around an axis of rotation C2.

The second diffuser plate 341 is so disposed that the diffusing surface 341a forms the angle of 45° with each of the optical axes AX2 and AX5. That is, the diffusing surface 341a inclines by 45° with respect to the optical axis AX2 of the second light collecting lens 33. The chief ray of the green light LG output from the second light collecting lens 33 is incident on the diffusing surface 341a at the angle of incidence of 45°.

The second collimator lens 35 is provided in the optical axis AX5 at the light exiting side of the second diffuser plate 341. The second collimator lens 35 is configured with a convex lens. The second collimator lens 35 parallelizes the green light LG output from the second diffuser plate 341 at a predetermined diffusion angle, and outputs the parallelized green light LG toward the light combiner 50.

The red light source section 40 includes the red laser diode array 41, a third collimator lens array 42, the third light collecting lens 43, a third diffuser 44, and the third collimator lens 45. The basic configuration of each of the elements of the red light source section 40 is the same as that of each of the elements of the blue light source section 20, and the same portions will therefore not be described.

The red laser diode array 41 includes multiple red laser diodes 411 arranged in an array. The red laser diodes 411 output red beams LR0 having a third wavelength band in the +Y direction. The third wavelength band is, for example, 640 nm±10 nm. The number of red laser diodes 411 and the arrangement thereof are not particularly limited to a specific number and a specific arrangement. The red laser diode array 41 in the present embodiment corresponds to the third laser light source section in the claims.

The third collimator lens array 42 is provided at the light exiting side of the red laser diode array 41. The third collimator lens array 42 includes multiple collimator lenses 421 provided in correspondence with the respective multiple red laser diodes 411. The collimator lenses 421 are each configured with a convex lens. The collimator lenses 421 parallelize the red beams LR0 output from the red laser diodes 411. The multiple red beams LR0 output from the third collimator lens array 42 are hereinafter collectively referred to as red light LR. The red light LR in the present embodiment corresponds to the third light in the claims.

The third light collecting lens 43 is provided at the light exiting side of the third collimator lens array 42. The third light collecting lens 43 is configured with a convex lens. The third light collecting lens 43 collects the red light LR output from the third collimator lens array 42, and outputs the collected red light LR toward the third diffuser plate 441.

The third diffuser 44 includes the third diffuser plate 441, which is a disk-shaped element, and a driver 442. The third diffuser plate 441 has a diffusing surface 441a, which diffusively reflects the red light LR output from the third light collecting lens 43. The diffusing surface 441a of the third diffuser plate 441 is located at the focal position of the third light collecting lens 43. The configuration of the driver 442 is the same as that of the driver 242 of the blue light source section 20. The driver 442 rotates the third diffuser plate 441 around an axis of rotation C3.

The third diffuser plate 441 is so disposed that the diffusing surface 441a forms the angle of 45° with each of the optical axes AX3 and AX4. That is, the diffusing surface 441a inclines by 45° with respect to the optical axis AX3 of the third light collecting lens 43. The chief ray of the red light LR output from the third light collecting lens 43 is incident on the diffusing surface 441a at the angle of incidence of 45°.

As described above, the three diffuser plates 241, 341, and 441 have the same basic configuration, but have different parameters such as the number of layers in the dielectric multilayer film and the film thickness thereof. The diffusion characteristics of the three dielectric multilayer films therefore differ from one another.

Specifically, the dielectric multilayer film of the first diffuser plate 241 is called a first dielectric multilayer film, the dielectric multilayer film of the second diffuser plate 341 is called a second dielectric multilayer film, and the dielectric multilayer film of the third diffuser plate 441 is called a third dielectric multilayer film. The first dielectric multilayer film is characterized by having reflectance in the blue wavelength band of the light incident thereon at the angle of incidence of 45° is higher than the reflectance in the green and red wavelength bands of the light incident thereon at the angle of incidence of 45°. The second dielectric multilayer film is characterized by having reflectance in the green wavelength band of the light incident thereon at the angle of incidence of 45° is higher than the reflectance in the blue and red wavelength bands of the light incident thereon at the angle of incidence of 45°. The third dielectric multilayer film is characterized by having reflectance in the red wavelength band of the light incident thereon at the angle of incidence of 45° is higher than the reflectance in the blue and green wavelength bands of the light incident thereon at the angle of incidence of 45°. That is, the dielectric multilayer films each have a characteristic in which the reflectance in the wavelength band of the light incident on the dielectric multilayer film is higher than the reflectance in the other wavelength bands. The reflectance of the first dielectric multilayer film in the blue wavelength band, the reflectance of the second dielectric multilayer film in the green wavelength band, and the reflectance of the third dielectric multilayer film in the red wavelength band described above are each 90% or higher, preferably 95% or higher.

In the present embodiment, 45° corresponds to the first angle of incidence, the second angle of incidence, and the third angle of incidence in the claims.

The third collimator lens 45 is provided in the optical axis AX4 at the light exiting side of the third diffuser plate 441. The third collimator lens 45 is configured with a convex lens. The third collimator lens 45 parallelizes the red light LR output from the third diffuser plate 441 at a predetermined diffusion angle, and outputs the parallelized red light LR toward the light combiner 50.

The light combiner 50 is provided at the position where the optical axes AX4 and AX5 intersect with each other. The light combiner 50 is configured with a cross dichroic prism. The cross dichroic prism includes a first dichroic mirror 501 and a second dichroic mirror 502. The first dichroic mirror 501 and the second dichroic mirror 502 are each disposed so as to intersect with the optical axes AX4 and AX5 at 45°. The first dichroic mirror 501 reflects the red light LR and transmits the green light LG and the blue light LB. The second dichroic mirror 502 reflects the blue light LB and transmits the green light LG and the red light LR. The light combiner 50 therefore combines the blue light LB output from the first diffuser plate 241, the green light LG output from the second diffuser plate 341, and the red light LR output from the third diffuser plate 441 with one another, and outputs the combined light LW, which is white light, toward the double-sided multi-lens array 60.

The blue light LB output from the blue laser diode array 21, the green light LG output from the green laser diode array 31, and the red light LR output from the red laser diode array 41 are each linearly polarized light having a specific polarization direction. The polarization directions of the blue light LB, the green light LG, and the red light LR, which constitute the combined light LW, coincide with one another when the three types of color light are output from the light combiner 50. Specifically, the polarization directions of the blue light LB, the green light LG, and the red light LR coincide with the direction perpendicular to the plane of FIG. 2. The three types of color light LB, LG, and LR are therefore each S-polarized light with respect to the dichroic mirrors 501 and 502 of the light combiner 50. The configuration described above can reduce transmission loss of the light at light-incident-side polarizers for the light modulators 400R, 400G, and 400B without using polarization converters. In addition, since the three types of color light LB, LG, and LR are each S-polarized with respect to the dichroic mirrors 501 and 502, the reflectance of the dichroic mirrors 501 and 502 can be increased.

The double-sided multi-lens array 60 and the superimposing lens 80 constitute an optical integration system. The optical integration system homogenizes the illuminance distribution of the combined light LW output from the light combiner 50 in an image formation region of each of the red light modulator 400R, the green light modulator 400G, and the blue light modulator 400B.

The double-sided multi-lens array 60 is provided in the optical axis AX5 at the light exiting side of the light combiner 50. The double-sided multi-lens array 60 is a multi-lens array in which a first multi-lens surface 60a and a second multi-lens surface 60b are integrated with each other into a single member. The first multi-lens surface 60a includes multiple lenses that divide the combined light LW output from the light combiner 50 into multiple sub-luminous fluxes. The multiple lenses are arranged in a matrix in a plane perpendicular to the optical axis AX5.

The second multi-lens surface 60b includes multiple lenses corresponding to the multiple lenses at the first multi-lens surface 60a. The second multi-lens surface 60b along with the downstream superimposing lens 80 forms images of the lenses at the first multi-lens surface 60a in the image formation region of each of the red light modulator 400R, the green light modulator 400G, and the blue light modulator 400B or in the vicinity of the image formation region. The multiple lenses are arranged in a matrix in a plane perpendicular to the optical axis AX5. The first multi-lens surface 60a and the second multi-lens surface 60b may be provided separately as surfaces of two multi-lens arrays.

The displacement apparatus 70 displaces the double-sided multi-lens array 60 in a direction perpendicular to the optical axis AX5 (direction along XZ plane). The displacement apparatus 70 is configured with a motor capable of vibrating or swinging the double-sided multi-lens array 60 at high speed. In the present embodiment, since the double-sided multi-lens array 60 is used instead of multi-lens arrays configured with two members, the double-sided multi-lens array 60 can be readily displaced by the displacement apparatus 70. Vibrating or swinging the double-sided multi-lens array 60 allows reduction in speckles that are likely to occur when laser diodes are used.

The superimposing lens 80 collects each of the multiple sub-luminous fluxes output from the double-sided multi-lens array 60 and superimposes the sub-luminous fluxes on one another in the image formation region of each of the red light modulator 400R, the green light modulator 400G, and the blue light modulator 400B or in the vicinity of the image formation region.

The color separation/light guide system 200 includes dichroic mirrors 240 and 220 and reflection mirrors 210, 230, and 250, as shown in FIG. 1. The color separation/light guide system 200 separates the white combined light LW output from the illuminator 700 into the red light LR, the green light LG, and the blue light LB, and guides the red light LR, the green light LG, and the blue light LB to the corresponding red light modulator 400R, green light modulator 400G, and blue light modulator 400B, respectively.

A field lens 300R is disposed between the color separation/light guide system 200 and the red light modulator 400R. A field lens 300G is disposed between the color separation/light guide system 200 and the green light modulator 400G. A field lens 300B is disposed between the color separation/light guide system 200 and the blue light modulator 400B.

The dichroic mirror 240 reflects the blue light LB and transmits the red light LR and the green light LG. The dichroic mirror 220 reflects the green light LG and transmits the red light LR. The reflection mirrors 210 and 230 each reflect the red light LR. The reflection mirror 250 reflects the blue light LB.

The red light modulator 400R is configured with a liquid crystal panel that modulates the red light LR in accordance with image information to form an image. The green light modulator 400G is configured with a liquid crystal panel that modulates the green light LG in accordance with image information to form an image. The blue light modulator 400B is configured with a liquid crystal panel that modulates the blue light LB in accordance with image information to form an image.

Although not shown, the light-incident-side polarizers are disposed between the field lens 300R and the red light modulator 400R, between the field lens 300G and the green light modulator 400G, and between the field lens 300B and the blue light modulator 400B. Light-exiting-side polarizers are disposed between the red light modulator 400R and the light combining system 500, between the green light modulator 400G and the light combining system 500, and between the blue light modulator 400B and the light combining system 500. The light-incident-side polarizers may not be provided when disturbance of the polarization caused by the optical system downstream from the illuminator 700 is acceptable.

The light combining system 500 combines the image light output from the red light modulator 400R, the image light output from the green light modulator 400G, and the image light output from the blue light modulator 400B with one another. The light combining system 500 is configured with a cross dichroic prism formed by bonding four rectangular prisms to each other and thus having a substantially square shape in a plan view. In the cross dichroic prism, dielectric multilayer films are provided at substantially X-shaped interfaces at which the rectangular prisms are bonded to each other.

The image light output from the light combining system 500 is enlarged and projected onto the screen SCR by the projection optical apparatus 600. The projection optical apparatus 600 is configured with multiple lenses.

### Effects of the First Embodiment

The illuminator 700 according to the present embodiment includes the blue laser diode array 21, which outputs the blue light LB, the green laser diode array 31, which outputs the green light LG, the red laser diode array 41, which outputs the red light LR, the first diffuser plate 241, which diffusively reflects the blue light LB output from the blue laser diode array 21, the second diffuser plate 341, which diffusively reflects the green light LG output from the green laser diode array 31, the third diffuser plate 441, which diffusively reflects the red light LR output from the red laser diode array 41, and the light combiner 50, which combines the blue light LB output from the first diffuser plate 241, the green light LG output from the second diffuser plate 341, and the red light LR output from the third diffuser plate 441 with one another, and outputs the combined light LW. The first diffuser plate 241 includes the first dielectric multilayer film, which reflects the blue light LB. The second diffuser plate 341 includes the second dielectric multilayer film, which reflects the green light LG. The third diffuser plate 441 includes the third dielectric multilayer film, which reflects the red light LR. The first dielectric multilayer film is characterized by having reflectance in the blue wavelength band of the light incident thereon at the angle of incidence of 45° is higher than the reflectance in the green and red wavelength bands of the light incident thereon at the angle of incidence of 45°. The second dielectric multilayer film is characterized by having reflectance in the green wavelength band of the light incident thereon at the angle of incidence of 45° is higher than the reflectance in the blue and red wavelength bands of the light incident thereon at the angle of incidence of 45°. The third dielectric multilayer film is characterized by having reflectance in the red wavelength band of the light incident thereon at the angle of incidence of 45° is higher than the reflectance in the blue and green wavelength bands of the light incident thereon at the angle of incidence of 45°.

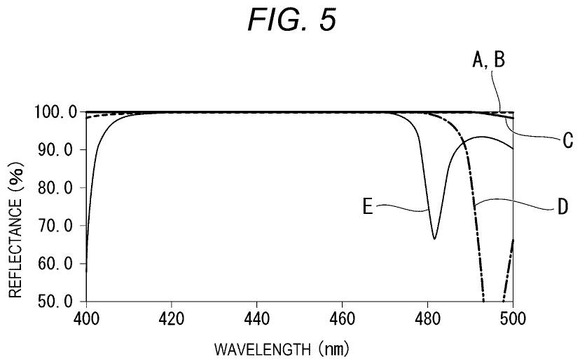

FIG. 5 shows an example of the spectral characteristics of one of the dielectric multilayer films. In FIG. 5 showing graphs, the horizontal axis represents the wavelength (nm), and the vertical axis represents the reflectance (%). The graph labeled with the symbol A shows a case where the angle of incidence is 0°, the graph labeled with the symbol B shows a case where the angle of incidence is 20°, the graph labeled with the symbol C shows a case where the angle of incidence is 40°, the graph labeled with the symbol D shows a case where the angle of incidence is 60°, and the graph labeled with the symbol E shows a case where the angle of incidence is 80°.

The dielectric multilayer film in the present example provides a stable reflectance of about 100%, for example, for light having a blue wavelength band ranging from 420 to 460 nm irrespective of the angle of incidence, as shown in FIG. 5. However, for light having a wavelength band exceeding 470 nm, the reflectance sharply decreases at a specific angle of incidence and over a specific wavelength band. As described above, it is difficult to realize a dielectric multilayer film having small dependence on the angle of incidence over a wide band from the blue wavelength band to the red wavelength band and stably providing high reflectance. To achieve desired characteristics, it is necessary to increase the number of dielectric films that constitute the dielectric multilayer film, for example, to 50 layers or more, but even this configuration has problems such as a large amount of light absorption, failure to provide desired reflectance, a decrease in reliability of the film, and a decrease in yield of the film. The related-art configuration, in which the blue light, the green light, and the red light are combined with one another and the combined light is then diffused by a single diffuser plate, therefore has a problem of difficulty realizing a high-efficiency illuminator.

In view of the problem described above, the present embodiment provides the first diffuser plate 241, on which the blue light LB is incident, with the first dielectric multilayer film, the second diffuser plate 341, on which the green light LG is incident, with the second dielectric multilayer film, and the third diffuser plate 441, on which the red light LR is incident, with the third dielectric multilayer film, with the dielectric multilayer films each having reflectance in the wavelength band of the color light incident on the dielectric multilayer film higher than the reflectance in the other wavelength bands. That is, dielectric multilayer films on which different types of color light are incident have different reflection characteristics, and the dielectric multilayer films each have a reflection characteristic optimized for the wavelength band of the color light incident on the dielectric multilayer film. The dielectric multilayer films each providing stable reflectance only in a specific wavelength band can therefore be used to form the diffuser plates 241, 341, and 441, so that a high-efficiency illuminator 700 can be realized.

The projector 10 according to the present embodiment includes the illuminator 700 according to the present embodiment, the light modulators 400R, 400G, and 400B, which modulate light containing the combined light LW output from the illuminator 700 in accordance with image information, and the projection optical apparatus 600, which projects the light modulated by the light modulators 400R, 400G, and 400B.

The configuration described above can realize a projector 10 that excels in light use efficiency.

### Second Embodiment

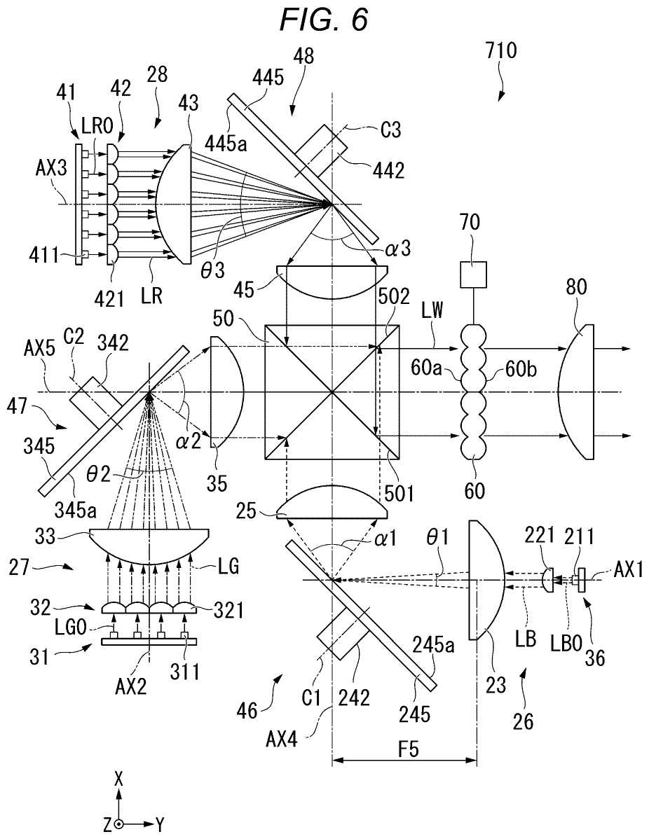

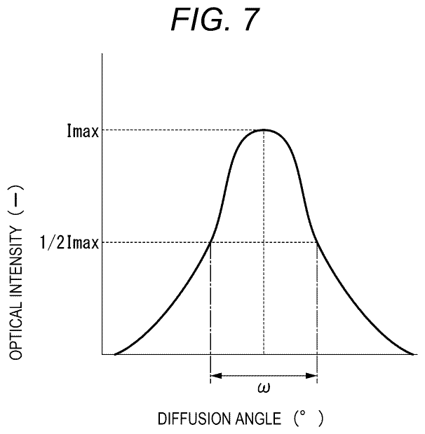

A second embodiment of the present disclosure will be described below with reference to FIGS. 6 and 7.

The basic configuration of a projector according to the second embodiment is the same as that of the projector according to the first embodiment, but the configuration of the illuminator differs from that of the illuminator according to the first embodiment. The basic configuration of the projector will therefore not be described.

FIG. 6 is a schematic configuration diagram of an illuminator 710 according to the second embodiment.

In FIG. 6, the elements common to those in FIG. 2 used in the description of the first embodiment have the same reference characters and will not be described.

The illuminator 710 according to the present embodiment includes a blue light source section 26, a green light source section 27, a red light source section 28, the light combiner 50, the double-sided multi-lens array 60, the displacement apparatus 70, and the superimposing lens 80, as shown in FIG. 6. The basic configuration of the illuminator 710 is the same as that of the illuminator 700 according to the first embodiment, but differs therefrom in the points described below.

In general, a laser diode emits light at different emission efficiencies on an emitted light color basis, the magnitude of the optical output from the laser diode also varies on an emitted light color basis. For example, the magnitude of the optical output per blue laser diode is greater than the magnitude of the optical output per green laser diode and per red laser diode. Meanwhile, the magnitudes of the optical outputs of the variety of types of color light required to generate white light having a predetermined color temperature differ from one another. For example, the magnitude of the optical output of the blue light necessary to produce white light having a predetermined color temperature is smaller than the magnitude of the optical output of each of the green light and the red light. The number of blue laser diodes is therefore generally smaller than the number of green laser diodes and the number of red laser diodes. As described above, to efficiently generate white light having a predetermined color temperature, it is desirable to vary the numbers of laser diodes on an emitted light color basis.

From the reason described above, in the illuminator 710 according to the present embodiment, the numbers of laser diodes provided in the light source sections 26, 27, and 28 are varied on an emitted light color basis. In the present embodiment, a blue laser diode array 36 is configured with 4 blue laser diodes 211. A green laser diode array 31 is configured with 16 green laser diodes 311. A red laser diode array 38 is configured with 24 red laser diodes 411. As described above, the number of red laser diodes 411 is larger than the number of green laser diodes 311, and the number of green laser diodes 311 is larger than the number of blue laser diodes 211. The configuration described above allows efficient generation of white light having a predetermined color temperature.

Although one blue laser diode 211 is shown in FIG. 6, four blue laser diodes 211 are actually arranged in the direction perpendicular to the plane of view. Similarly, although four green laser diodes 311 are shown in FIG. 6, four rows of green laser diodes 311 are actually arranged in the direction perpendicular to the plane of view. Although six red laser diodes 411 are shown in FIG. 6, four rows of red laser diodes 411 are actually arranged in the direction perpendicular to the plane of view. Therefore, FIG. 6 is a view viewed in the direction in which the numbers of three different color laser diodes differ from one another, and a view viewed in the direction perpendicular to FIG. 6 shows four laser diodes arranged in each of the laser diode arrays.

In the present embodiment, the diffusion characteristics of diffuser plates 245, 345, and 445 of diffusers 46, 47, and 48 differ from one another. Specifically, the diffusibility of the first diffuser plate 245 for the blue light LB is greater than the diffusibility of the second diffuser plate 345 for the green light LG, and the diffusibility of the second diffuser plate 345 for the green light LG is greater than the diffusibility of the third diffuser plate 445 for the red light LR. As an example, let cosⁿθ be the light orientation characteristics of the light having been diffused by the diffuser plates 245, 345, and 445, the light orientation characteristic of the first diffuser plate 245, on which the blue light LB is incident, is cosⁿθ: n=10. The light orientation characteristic of the second diffuser plate 345, on which the green light LG is incident, is cosⁿθ: n=12. The light orientation characteristic of the third diffuser plate 445, on which the red light LR is incident, is cosⁿθ: n=15. According to the expression described above, the smaller the value of n, the greater the diffusibility. To realize the differences described above in diffusion characteristics, the shapes, dimensions, and other factors of the uneven structures of the diffuser plates 245, 345, and 445 may be differentiated from one another.

The diffusibility in the present specification is defined as follows: parallelized light is caused to be incident on the diffusing surface of a diffuser plate at right angles, and the width of the full angle at half maximum, where the diffused light has 50% of the maximum intensity, in the optical intensity distribution curve of the diffused light is defined as the diffusibility. FIG. 7 shows an example of the optical intensity distribution curve of the diffused light. In FIG. 7, the horizontal axis represents the diffusion angle (°), and the vertical axis represents the optical intensity (relative value). The diffusion angle width w shown in FIG. 7 corresponds to the diffusibility defined as described above. Therefore, the larger the diffusion angle width w, the greater the diffusibility, and the smaller the diffusion angle width w, the smaller the diffusibility.

### Effects of the Second Embodiment

Also in the present embodiment, dielectric multilayer films each providing stable reflectance only in a specific wavelength band can be used to form the diffuser plates 245, 345, and 445, so that a high-efficiency illuminator 710 can be realized, as in the first embodiment.

In the present embodiment, in particular, the widths of the angles of incidence of the three types of color light LB, LG, and LR incident on the diffuser plates 245, 345, and 445 differ from one another due to the difference in the number of laser diodes of the light source sections 26, 27, and 28. Let θ1 be the width of the angle of incidence of the blue light LB to be incident on the first diffuser plate 245, θ2 be the width of the angle of incidence of the green light LG to be incident on the second diffuser plate 345, and θ3 be the width of the angle of incidence of the red light LR to be incident on the third diffuser plate 445, as shown in FIG. 6. Since the number of laser diodes is larger in the order of the blue light source section 26, the green light source section 27, and the red light source section 28, the diameters of the luminous fluxes output from the collimator lens arrays 22, 32, and 42 are greater in the order of the blue light LB, the green light LG, and the red light LR. Therefore, when the light collecting lenses 23, 33, and 43 have the same focal length, the widths of the angles of incidence of the three types of color light LB, LG, and LR are greater in the order of the width of the angle of incidence θ1, the width of the angle of incidence θ2, and the width of the angle of incidence θ3.

To equalize diffusion angles α1, α2, and α3 of the three types of diffused color light LB, LG, and LR, it is necessary to relatively strongly diffuse the blue light LB having a relatively small width of the angle of incidence and relatively weakly diffuse the red light LR having a relatively large width of the angle of incidence. Therefore, in the present embodiment, the diffusibility of the first diffuser plate 245 for the blue light LB is greater than the diffusibility of the second diffuser plate 345 for the green light LG, and the diffusibility of the second diffuser plate 345 for the green light LG is greater than the diffusibility of the third diffuser plate 445 for the red light LR. The diffusion angles α1, α2, and α3 of the three types of diffused color light LB, LG, and LR can therefore be equalized, so that color unevenness of the combined light LW output from the illuminator 710 can be reduced.

### Third Embodiment

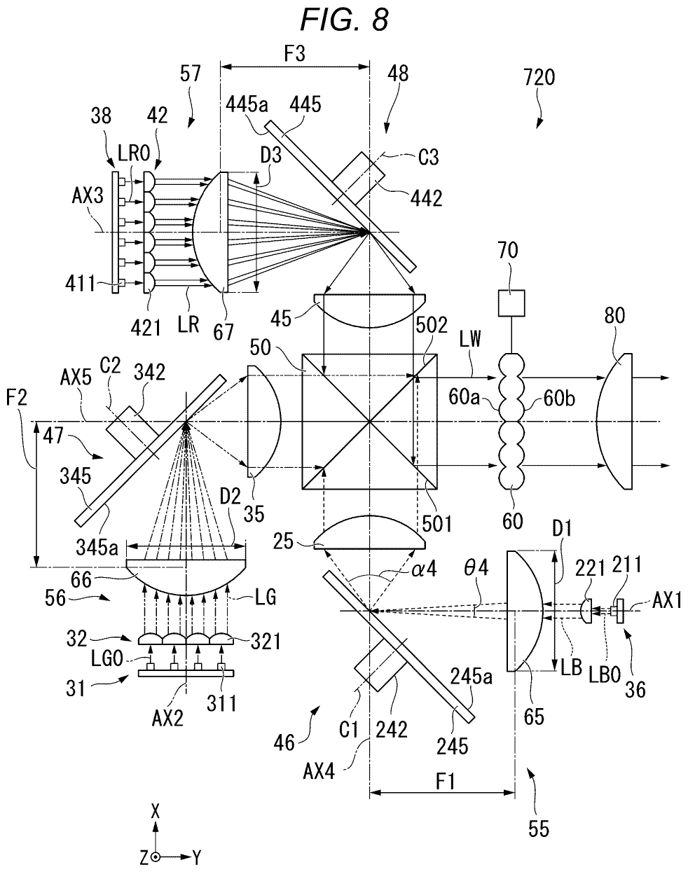

A third embodiment of the present disclosure will be described below with reference to FIG. 8.

The basic configuration of a projector according to the third embodiment is the same as that of the projector according to the first embodiment, and a configuration of the illuminator differs from that of the illuminator according to the first embodiment. The basic configuration of the projector will therefore not be described.

FIG. 8 is a schematic configuration diagram of an illuminator 720 according to the third embodiment.

In FIG. 8, the elements common to those in FIG. 2 used in the description of the first embodiment have the same reference characters and will not be described.

The illuminator 720 according to the present embodiment includes a blue light source section 55, a green light source section 56, a red light source section 57, the light combiner 50, the double-sided multi-lens array 60, the displacement apparatus 70, and the superimposing lens 80, as shown in FIG. 8. The basic configuration of the illuminator 720 is the same as that of the illuminator 710 according to the second embodiment, but differs therefrom in the points described below.

In the illuminator 720 according to the present embodiment, focal lengths F1, F2, and F3 of light collecting lenses 65, 66, and 67 provided in the light source sections 55, 56, and 57 differ from one another on an emitted light color basis. Specifically, the focal length F1 of the first light collecting lens 65 of the blue light source section 55 is shorter than the focal length F2 of the second light collecting lens 66 of the green light source section 56. The focal length F2 of the second light collecting lens 66 of the green light source section 56 is shorter than the focal length F3 of the third light collecting lens 67 of the red light source section 57. That is, F1<F2<F3 is satisfied. The focal length F1 may be equal to the focal length F2. That is, F1≤F2<F3 may be satisfied.

Furthermore, outer diameters D1, D2, and D3 of the light collecting lenses 65, 66, and 67 provided in the light source sections 55, 56, and 57 may differ from one another on an emitted light color basis. Specifically, the outer diameter D1 of the first light collecting lens 65 of the blue light source section 55 may be smaller than the outer diameter D2 of the second light collecting lens 66 of the green light source section 56. The outer diameter D2 of the second light collecting lens 66 of the green light source section 56 may be smaller than the outer diameter D3 of the third light collecting lens 67 of the red light source section 57. That is, D1<D2<D3 may be satisfied. The outer diameter D1 may be equal to the outer diameter D2. That is, D1≤D2<D3 may be satisfied.

### Effects of the Third Embodiment

Also in the present embodiment, dielectric multilayer films each providing stable reflectance only in a specific wavelength band can be used to form the diffuser plates 245, 345, and 445, so that a high-efficiency illuminator 720 can be realized, as in the first embodiment.

In the present embodiment, it is assumed that the focal length F3 of the third light collecting lens 67 of the red light source section 57 is equal to the focal length of the third light collecting lens 43 in the second embodiment. In this case, for example, when attention is paid to the blue light source section 55, since the focal length F1 of the first light collecting lens 65 is shorter than a focal length F5 of the first light collecting lens 23 in the second embodiment shown in FIG. 6, a width of the angle of incidence θ4 of the blue light LB to be incident on the first diffuser plate 245 is greater than the width of the angle of incidence θ1 of the blue light LB in the second embodiment. Therefore, a diffusion angle α4 of the diffused blue light LB can be made comparable with the diffusion angle α1 in the second embodiment without making the diffusibility of the first diffuser plate 245 as large as the diffusibility of the first diffuser plate 245 in the second embodiment. The uneven structure of the first diffuser plate 245 can therefore be readily designed and manufactured. The blue light source section 55 has been presented above by way of example, and the second diffuser plate 345 of the green light source section 56 can provide the same effects as those provided by the first diffuser plate 245.

In the blue light source section 55 and the green light source section 56, in each of which the number of laser diodes is smaller than that in the red light source section 57, each luminous flux that enters each of the light collecting lenses 65 and 66 has a diameter smaller than that in the red light source section 57, so that the light collecting lenses 65 and 66 can be smaller in terms of outer diameter than that in the red light source section 57. The size of the illuminator 720 can therefore be reduced.

The technical scope of the present disclosure is not limited to the embodiments described above, and a variety of changes can be made thereto without departing from the intent of the present disclosure. An aspect of the present disclosure can be achieved by an appropriate combination of the characteristic portions in the embodiments described above.

The illuminator according to each of the embodiments described above includes the rotary diffuser plate, and the diffuser plate may not necessarily be rotatable, and may be fixed.

In addition, the specific descriptions of the shapes, the numbers, the arrangements, the materials, and other factors of the elements of the illuminator and the projector are not limited to those in the embodiments described above and can be changed as appropriate. The aforementioned embodiments have been described with reference to the case where the illuminator according to the present disclosure is incorporated in a projector using liquid crystal panels, but not necessarily. The illuminator according to the present disclosure may be incorporated in a projector using digital micromirror devices as the light modulators. The projector may not include multiple light modulators and may instead be a single-panel projector including only one light modulator.

The aforementioned embodiments have been described with reference to the case where the illuminator according to the present disclosure is incorporated in a projector, but not necessarily. The illuminator according to the present disclosure may be incorporated in a lighting apparatus, a headlight of an automobile, and other apparatuses.

### Summary of Present Disclosure

The present disclosure will be summarized below as additional remarks.

### Additional Remark 1

An illuminator including:
a first laser light source section configured to output first light having a first wavelength band;
a second laser light source section configured to output second light having a second wavelength band different from the first wavelength band;
a first diffusing member configured to diffusively reflect the first light output from the first laser light source section;
a second diffusing member configured to diffusively reflect the second light output from the second laser light source section; and
a light combiner configured to combine the first light output from the first diffusing member and the second light output from the second diffusing member with each other and output the combined light,
wherein the first diffusing member includes a first dielectric multilayer film configured to reflect the first light,
the second diffusing member includes a second dielectric multilayer film configured to reflect the second light, and
assuming that an angle of incidence of a chief ray of the first light to be incident on the first diffusing member is called a first angle of incidence, and that an angle of incidence of a chief ray of the second light to be incident on the second diffusing member is called a second angle of incidence,
the first dielectric multilayer film is characterized by having reflectance in the first wavelength band of the light incident thereon at the first angle of incidence is higher than reflectance in the second wavelength band of the light incident thereon at the first angle of incidence, and
the second dielectric multilayer film is characterized by having reflectance in the second wavelength band of the light incident thereon at the second angle of incidence is higher than reflectance in the first wavelength band of the light incident thereon at the second angle of incidence.

The configuration according to the additional remark 1, in which a dielectric multilayer film having high reflectance only in the first or second wavelength band may be used to form each of the diffusing members, can realize a high-efficiency illuminator with the configuration of the dielectric multilayer film simplified.

### Additional Remark 2

The illuminator according to the additional remark 1, further including:
a third laser light source section configured to output third light having a third wavelength band different from the first and second wavelength bands; and
a third diffusing member configured to diffusively reflect the third light output from the third laser light source section,
wherein the light combiner is configured to combine the first light, the second light, and the third light output from the third diffusing member with one another,
the third diffusing member includes a third dielectric multilayer film configured to reflect the third light, and
assuming that an angle of incidence of a chief ray of the third light to be incident on the third diffusing member is called a third angle of incidence,
the third dielectric multilayer film is characterized by having reflectance in the third wavelength band of the light incident thereon at the third angle of incidence is higher than reflectance in the first and second wavelength bands of the light incident thereon at the third angle of incidence.

The configuration according to the additional remark 2 allows the color gamut of the combined light to be widened.

### Additional Remark 3

The illuminator according to the additional remark 2, wherein the first wavelength band is a blue wavelength band, the second wavelength band is a green wavelength band, and the third wavelength band is a red wavelength band.

The configuration according to the additional remark 3 can realize an illuminator that outputs white light as the combined light.

### Additional Remark 4

The illuminator according to the additional remark 3,
wherein the first, second, and third laser light source sections are each configured with a laser diode,
the number of laser diodes that constitute the third laser light source section is larger than the number of laser diodes that constitute the second laser light source section, and
the number of laser diodes that constitute the second laser light source section is larger than the number of laser diodes that constitute the first laser light source section.

The configuration according to the additional remark 4 allows efficient generation of white light having a predetermined color temperature in accordance with differences in light emission efficiency of the laser diodes.

### Additional Remark 5

The illuminator according to the additional remark 4, wherein
diffusibility of the first diffusing member for the first light is greater than diffusibility of the second diffusing member for the second light, and
the diffusibility of the second diffusing member for the second light is greater than diffusibility of the third diffusing member for the third light.

The configuration according to the additional remark 5 allows the orientation angles of the variety of types of diffused light to be equalized, so that color unevenness of the combined light output from the illuminator can be reduced.

### Additional Remark 6

The illuminator according to any one of the additional remarks 3 to 5, further including:
a first light collecting lens configured to collect the first light output from the first laser light source section and output the collected first light toward the first diffusing member;
a second light collecting lens configured to collect the second light output from the second laser light source section and output the collected second light toward the second diffusing member; and
a third light collecting lens configured to collect the third light output from the third laser light source section and output the collected third light toward the third diffusing member.

The configuration according to the additional remark 6 allows reduction in size of each of the diffusing members.

### Additional Remark 7

The illuminator according to the additional remark 6, wherein
a focal length of the first light collecting lens is shorter than or equal to a focal length of the second light collecting lens, and
the focal length of the second light collecting lens is shorter than a focal length of the third light collecting lens.

The configuration according to the additional remark 7, which eliminates the necessity of excessively increasing the diffusibility of the first and second diffusing members, allows the diffusion structure of each of the first and second diffusing members to be readily designed and manufactured.

### Additional Remark 8

The illuminator according to the additional remark 6 or 7, wherein
an outer diameter of the first light collecting lens is smaller than or equal to an outer diameter of the second light collecting lens, and
the outer diameter of the second light collecting lens is smaller than an outer diameter of the third light collecting lens.

The configuration according to the additional remark 8 allows reduction in size of the illuminator.

### Additional Remark 9

The illuminator according to any one of the additional remarks 2 to 8, wherein the first, second, and third diffusing members each include a light transmissive substrate and a dielectric multilayer film.

The configuration according to the additional remark 9 can simplify the step of manufacturing the diffusing members.

### Additional Remark 10

The illuminator according to any one of the additional remarks 2 to 8, wherein the first, second, and third diffusing members each include a light transmissive substrate, a metal film, and a dielectric multilayer film.

The configuration according to the additional remark 10, in which the metal film and the dielectric multilayer film can provide the reflection function, allows reduction in the number of layers in each of the dielectric multilayer films.

### Additional Remark 11

The illuminator according to any one of the additional remarks 2 to 8, wherein the first, second, and third diffusing members each include a metal substrate and a dielectric multilayer film.

The configuration according to the additional remark 11 can simplify the configuration of each of the diffusing members.

### Additional Remark 12

The illuminator according to any one of the additional remarks 2 to 11, wherein the first light, the second light, and the third light are each linearly polarized light, and a polarization direction of the first light contained in the combined light, a polarization direction of the second light contained in the combined light, and a polarization direction of the third light contained in the combined light coincide with one another.

The configuration according to the additional remark 12 allows omission of the light-incident-side polarizer plates, and further allows formation of illumination light optimum for polarization-based light modulators such as liquid crystal panels.

### Additional Remark 13

The illuminator according to any one of the additional remarks 2 to 12, further including a driver configured to rotate each of the first, second, and third diffusing members around an axis of rotation that intersects with a diffusing surface of the diffusing member.

The configuration according to the additional remark 13 allows reduction in speckles caused by using the solid-state light sources.

### Additional Remark 14

The illuminator according to any one of the additional remarks 1 to 13, further including:
a double-sided multi-lens array provided at a light exiting side of the light combiner; and
a displacement apparatus configured to displace the double-sided multi-lens array in a direction that intersects with an optical axis thereof.

The configuration according to the additional remark 14 allows reduction in speckles caused by using the solid-state light sources.

### Additional Remark 15

A projector including:
the illuminator according to any one of the additional remarks 1 to 14;
a light modulator configured to modulate light containing the combined light output from the illuminator in accordance with image information; and
a projection optical apparatus configured to project the light modulated by the light modulator.

The configuration according to the additional remark 15 can realize a projector having high light use efficiency.

What is claimed is:

1. An illuminator comprising:
a first laser light source section configured to output first light having a first wavelength band;
a second laser light source section configured to output second light having a second wavelength band different from the first wavelength band;
a first diffusing member configured to diffusively reflect the first light output from the first laser light source section;
a second diffusing member configured to diffusively reflect the second light output from the second laser light source section; and
a light combiner configured to combine the first light output from the first diffusing member and the second light output from the second diffusing member with each other and output the combined light,
wherein the first diffusing member includes a first dielectric multilayer film configured to reflect the first light,
the second diffusing member includes a second dielectric multilayer film configured to reflect the second light, and
assuming that an angle of incidence of a chief ray of the first light to be incident on the first diffusing member is called a first angle of incidence, and that an angle of incidence of a chief ray of the second light to be incident on the second diffusing member is called a second angle of incidence,
the first dielectric multilayer film is characterized by having reflectance in the first wavelength band of the light incident thereon at the first angle of incidence is higher than reflectance in the second wavelength band of the light incident thereon at the first angle of incidence, and
the second dielectric multilayer film is characterized by having reflectance in the second wavelength band of the light incident thereon at the second angle of incidence is higher than reflectance in the first wavelength band of the light incident thereon at the second angle of incidence.

2. The illuminator according to claim 1, further comprising:
a third laser light source section configured to output third light having a third wavelength band different from the first and second wavelength bands; and
a third diffusing member configured to diffusively reflect the third light output from the third laser light source section,
wherein the light combiner is configured to combine the first light, the second light, and the third light output from the third diffusing member with one another,
the third diffusing member includes a third dielectric multilayer film configured to reflect the third light, and
assuming that an angle of incidence of a chief ray of the third light to be incident on the third diffusing member is called a third angle of incidence,
the third dielectric multilayer film is characterized by having reflectance in the third wavelength band of the light incident thereon at the third angle of incidence is higher than reflectance in the first and second wavelength bands of the light incident thereon at the third angle of incidence.

3. The illuminator according to claim 2, wherein the first wavelength band is a blue wavelength band, the second wavelength band is a green wavelength band, and the third wavelength band is a red wavelength band.

4. The illuminator according to claim 3,
wherein the first, second, and third laser light source sections are each configured with a laser diode,
a number of laser diodes that constitute the third laser light source section is larger than a number of laser diodes that constitute the second laser light source section, and
the number of laser diodes that constitute the second laser light source section is larger than a number of laser diodes that constitute the first laser light source section.

5. The illuminator according to claim 4, wherein
diffusibility of the first diffusing member for the first light is greater than diffusibility of the second diffusing member for the second light, and
the diffusibility of the second diffusing member for the second light is greater than diffusibility of the third diffusing member for the third light.

6. The illuminator according to claim 3, further comprising:
a first light collecting lens configured to collect the first light output from the first laser light source section and output the collected first light toward the first diffusing member;
a second light collecting lens configured to collect the second light output from the second laser light source section and output the collected second light toward the second diffusing member; and
a third light collecting lens configured to collect the third light output from the third laser light source section and output the collected third light toward the third diffusing member.

7. The illuminator according to claim 6, wherein
a focal length of the first light collecting lens is shorter than or equal to a focal length of the second light collecting lens, and
the focal length of the second light collecting lens is shorter than a focal length of the third light collecting lens.

8. The illuminator according to claim 6, wherein
an outer diameter of the first light collecting lens is smaller than or equal to an outer diameter of the second light collecting lens, and
the outer diameter of the second light collecting lens is smaller than an outer diameter of the third light collecting lens.

9. The illuminator according to claim 2, wherein the first, second, and third diffusing members each include a light transmissive substrate and a dielectric multilayer film.

10. The illuminator according to claim 2, wherein the first, second, and third diffusing members each include a light transmissive substrate, a metal film, and a dielectric multilayer film.

11. The illuminator according to claim 2, wherein the first, second, and third diffusing members each include a metal substrate and a dielectric multilayer film.

12. The illuminator according to claim 2, wherein
the first light, the second light, and the third light are each linearly polarized light, and
a polarization direction of the first light contained in the combined light, a polarization direction of the second light contained in the combined light, and a polarization direction of the third light contained in the combined light coincide with one another.

13. The illuminator according to claim 2, further comprising a driver configured to rotate each of the first, second, and third diffusing members around an axis of rotation that intersects with a diffusing surface of the diffusing member.

14. The illuminator according to claim 1, further comprising:
a double-sided multi-lens array provided at a light exiting side of the light combiner; and
a displacement apparatus configured to displace the double-sided multi-lens array in a direction that intersects with an optical axis thereof.

15. A projector comprising:
the illuminator according to claim 1;
a light modulator configured to modulate light containing the combined light output from the illuminator in accordance with image information; and
a projection optical apparatus configured to project the light modulated by the light modulator.
